(19) United States
(12) Patent Application Publication
(10) Pub. No.: US 2024/0412964 A1
(43) Pub. Date: Dec. 12, 2024

(54) ANALYTICAL SYSTEM AND ANALYTICAL METHOD

(71) Applicants: SHIMADZU CORPORATION, Kyoto-shi (JP); Qingdao Single Cell Biotech. Co., Ltd., Qingdao Shandong Province (CN)

(72) Inventors: Zhi GENG, Shanghai (CN); Wenjian SUN, Shanghai (CN); Yuetong JI, Qingdao Shandong Province (CN); Xibao HOU, Qingdao (CN)

(21) Appl. No.: 18/733,215

(22) Filed: Jun. 4, 2024

(30) Foreign Application Priority Data
Jun. 6, 2023 (CN) 202310666601.5

(51) Int. Cl. H01J 49/04; H01J 49/02

(52) U.S. Cl. CPC H01J 49/0409; H01J 49/025; H01J 49/0445

(57) ABSTRACT

The technical solution of the present disclosure provides an analytical system and an analytical method, which can quickly and automatically capture, recognize and detect samples using a simpler device structure, improve detection efficiency and reduce costs. The analytical system includes: a fluid system, where solution containing sample particles is stored in or flowing through; an optical tweezer arranged towards the fluid system and configured to capture the sample particles in the fluid system; an optical detector configured to detect optical information of the sample particles in the fluid system; and a mass spectrometer arranged at a succeeding stage of the fluid system. The sample particles in the fluid system are at least partially driven by the optical tweezer toward the mass spectrometer.

### TECHNICAL FIELD

The present disclosure relates to a technical field of analysis, in particular to an analytical system and an analytical method.

### BACKGROUND ART

An optical tweezer is an optical potential well formed by strongly converged laser beams, can capture and drag cells using optical gradient force, can even penetrate into the cells to control organelles, and are widely used in cell biology research.

Through research, it is found that the optical tweezer is matched with an analytical instrument, so that the cells can be accurately captured from solution, and meanwhile, a substance composition, a molecular structure, molecular energy level and other information of the cells are obtained. In this regard, a large number of researchers have proposed various optical tweezer-based analytical systems and analytical methods.

In a literature of “Research Current Status of Optical Tweezer Technology” published by Li Yinmei et al. in 2015, a Raman spectrum for detecting single vesicles is disclosed, in which an optical tweezer technology is combined with a Raman spectrum detection technology, and Raman signals of single cells or vesicles are captured and measured using Raman optical tweezers to obtain composition or structure information of substances in the cells. However, the material composition information at a molecular level cannot be further obtained.

U.S. Pat. No. 7,767,435B2 proposes a method and method for biochemical detection and analysis of subcellular regions of single cells, in which an optical tweezer technology are combined with a mass spectrometer, cells or organelles are captured and separated using a force generator (optical tweezer and the like) technology, and then the separated cells and organelles are transported through a microfluidic channel to an optical or ionization-based sensitive detector (mass spectrometer and the like) for detection, which can complete separation, encapsulation, transportation and detection of cells in one device.

Ali et al. discloses a method for selecting and measuring target single cells using Raman spectrum and mass spectrum in sequence in “Single-Cell Screening of Tamoxifen Abundance and Effect Using Mass Spectrometry and Raman-Spectroscopy” (Anal. Chem., 2019, 91, 2710), which can simultaneously provide pharmacodynamic and pharmacokinetic information of single cells. However, in the above process, manual operation is required for single cell operation and movement, an automation level is low, and the Raman spectrum and the mass spectrum test flux are mismatched with each other, so that test efficiency is greatly limited.

In summary, although the combined analysis of single cell spectrum and mass spectrum has great significance in the fields of biological research, drug development, tumor treatment and the like, there is no single cell analytical instrument at present to automatically detect spectrum and mass spectrum information of single cells, the existing single cell spectrum and mass spectrum combined analysis technology is limited by the complexity of manual operation, resulting in difficult implementation and low analysis efficiency, and is difficult to popularize in specific application fields. Therefore, an improved technical solution is required to solve the above problems of existing cell analysis technology.

### SUMMARY OF THE INVENTION

In view of the above problems in the prior art, a technical solution of the present disclosure provides an analytical system and an analytical method, which can automatically capture, recognize and detect samples by using a simpler device structure, obtain spectrum and mass spectrum information of sample particles, improve detection efficiency and reduce cost.

There is provided an analytical system according to a first aspect of the present disclosure, the analytical system including: a fluid system, where solution containing sample particles is stored in or flowing through; an optical tweezer arranged towards the fluid system and configured to capture the sample particles in the fluid system; an optical detector configured to detect optical information of the sample particles in the fluid system; and a mass spectrometer arranged at a succeeding stage of the fluid system. The sample particles in the fluid system are at least partially driven by the optical tweezer toward the mass spectrometer.

According to the technical solution, the optical tweezer can capture and control single sample particles from the solution, the optical detector can recognize the sample particles and detect the optical information of the sample particles, when in use, the optical detector can be used for detecting the sample particles captured by the optical tweezer while the optical tweezer is used for capturing the sample particles to obtain the optical information of the sample particles, or the optical detector can be used for detecting the sample particles to obtain the optical information of the sample particles, and then the optical tweezer is used for capturing the single sample particles in the sample particles, and finally, the sample particles can be moved at least partially by the optical tweezer, and the single sample particles are sent into the mass spectrometer for detection. The analytical technology can automatically detect the optical and mass spectrometry information of the sample particles, and since the optical tweezer is used to directly capture, in-situ detect and move the sample particles in the fluid system, there is no need to manually transfer samples, so that the test flux of the optical detector can be matched with the mass spectrometer, thereby quickly, accurately, and automatically completing the recognition, capture, control, and detection processes of the sample particles.

As an exemplary technical solution of the present disclosure, the sample particles may be one or a combination of cells, organelles, and single-celled microorganisms.

As an exemplary technical solution of the present disclosure, the fluid system includes a reservoir storing the solution and a fluid channel communicating with the reservoir, and the optical tweezer is operable to move between the reservoir and the fluid channel, thereby the sample particles being moved from the reservoir to the fluid channel at least partially by optical gradient force.

According to the technical solution, the optical tweezer captures and fixes single sample particles in the reservoir, then through relative movement between the optical tweezer and the fluid system, an optical potential well generated by the optical tweezer in the fluid system is displaced, and the sample particles fixed to the optical potential well also move into the fluid channel under the driving of the optical gradient force. The reservoir and the fluid channel are respectively arranged to prevent the sample particles that have not separated and recognized from flowing into the mass spectrometer along with the solution, and the optical gradient force is used to transport the sample particles from the reservoir to the fluid channel, so that the optical information of the sample particles can be obtained before or while the sample particles are transported.

As an exemplary technical solution of the present disclosure, fluid in the fluid channel flows toward an outlet end, an ionization device is arranged at the outlet end of the fluid channel, and an ion inlet of the mass spectrometer is arranged opposite to the ionization device.

According to the technical solution, as long as the optical tweezer moves at the inlet between the reservoir and the fluid channel, and the single sample particles are transported to the inlet of the fluid channel, the sample particles may flow in the fluid channel along with the fluid in the fluid channel to the ionization device at the outlet, the ionized sample particles can directly enter the ion inlet of the mass spectrometer for detection, a transport distance of the optical tweezer is shortened, and transporting the sample particles through the fluid can further improve a transport speed of the sample particles on the basis of ensuring the completion of the separation, recognition and optical detection of the sample particles, the output flux of the sample particles in the fluid system is increased, and the detection efficiency of the analytical system is improved.

As an exemplary technical solution of the present disclosure, the fluid system further includes: a nozzle opening formed at the fluid channel and located downstream of the reservoir; and an inkjet actuator arranged in correspondence with the nozzle opening, droplets containing the sample particles expelled one by one through the nozzle opening.

According to the technical solution, a single cell printer (SCP) technology generates small droplets wrapping a single cell by using a piezoelectric jetting principle, so that separation of different cell individuals is realized, detection flux can be remarkably improved, but cells cannot be positioned and screened in a printing process, so that empty droplets or droplets of multiple cells can be generated. An upstream of the fluid system is provided with the optical tweezer and the optical detector, and after the sample particles in the reservoir are captured, separated, recognized and detected, the sample particles are transported to the fluid channel by the optical tweezer, so that droplets containing the single sample particles can be expelled one by one from the nozzle opening by setting the transport speed of the optical tweezer and a printing speed of the inkjet actuator.

As an exemplary technical solution of the present disclosure, the fluid channel includes a first fluid channel and a second fluid channel, an outlet of the reservoir, the nozzle opening and the inkjet actuator are all connected to the first fluid channel, the ionization device is connected to the second fluid channel, and the second fluid channel has a channel opening arranged in correspondence with the nozzle opening, for receiving the droplets expelled through the nozzle opening.

According to the technical solution, droplets containing single sample particles printed by the inkjet actuator enter the channel opening of the second fluid channel from the nozzle opening and are ionized in the second fluid channel, so that the single sample particles can be ionized in the single droplets without affecting each other, the ionized single sample ions directly enter the mass spectrometer through the second fluid channel for detection, which is faster and more accurate, and particularly, the second fluid channel can be formed into a nano-tip, and high-voltage electricity (1 kV-5 kV) is applied to sample droplets through electrodes. Under the action of a high-voltage electric field, droplets containing single sample particles are ejected from the tip end of the second fluid channel to form an electrospray, and sample ions in the electrospray enter a sampling port of the mass spectrometer to perform mass spectrometry detection.

As an exemplary technical solution of the present disclosure, the fluid system further includes a target plate arranged below the nozzle opening.

According to the technical solution, the droplets containing the single sample particles printed by the inkjet actuator are dropped onto the target plate through the nozzle opening, one target plate can simultaneously arrange a plurality of droplets, so that mass spectrometry detection can be performed after the plurality of droplets on the target plate are ionized, and particularly, the target plate on which the droplets are arranged may be directly used as a target plate of a matrix-assisted laser desorption/ionization device, thereby completing ionization in the matrix-assisted laser desorption/ionization device.

As an exemplary technical solution of the present disclosure, the ionization device is an electrospray ionization source (ESI), an atmospheric pressure chemical ionization source (APCI), an inductively coupled plasma ionization source (ICP), or matrix-assisted laser desorption/ionization source (MALDI).

As an exemplary technical solution of the present disclosure, the optical detector is one or a combination of a Raman spectrometer, an infrared spectrometer, a fluorescence analyzer, or an optical microscope.

As an exemplary technical solution of the present disclosure, the analytical system further includes an image recognition system configured to recognize the sample particles from the solution.

According to the technical solution, the image recognition system can screen and recognize the sample particles in the solution in a larger range before capturing the sample particles, thereby further improving the capture efficiency of the optical tweezer on the sample particles and the detection speed of the optical detector.

There is provided an analytical method according to a second aspect of the present disclosure, the analytical method including:
a capturing step for capturing sample particles in solution which is stored in or flowing through a fluid system by an optical tweezer;
an optical analysis step for detecting optical information of the sample particles; and
a mass spectrometry detection step for driving the sample particles towards a mass spectrometer at least partially by the optical tweezer and detecting mass spectrum information of the sample particles.

As an exemplary technical solution of the present disclosure, the optical analysis step is performed simultaneously with the capturing step, or the optical analysis step is performed before the capturing step.

### DESCRIPTIONS OF THE DRAWINGS

FIG. 1 is a schematic structural diagram of an analytical system according to an embodiment of the present disclosure;

FIG. 2 is a schematic structural diagram of an exemplary analytical system according to the embodiment of the present disclosure;

FIG. 3 is a schematic structural diagram of an analytical system in an exemplary embodiment of the present disclosure;

FIG. 4 is a schematic structural diagram of an analytical system in another exemplary embodiment of the present disclosure;

FIG. 5 is a flowchart of a first operation mode of an analytical method according to the embodiment of the present disclosure; and

FIG. 6 is a flowchart of a second operation mode of the analytical method according to the embodiment of the present disclosure.

### LIST OF REFERENCE NUMERALS

Fluid system 100; sample particle 10; reservoir 11; fluid channel 12; first fluid channel 12a; second fluid channel 12b; fluid inlet 121; fluid outlet 122; reservoir communication port 123; nozzle opening 124; inkjet actuator 125; channel opening 126; target plate 127; ionization device 13; optical tweezer 200; laser generator 21; optical detector 300; mass spectrometer 400; and ion inlet 41.

### DETAILED DESCRIPTION

Some embodiments of the present disclosure are described below with reference to the accompanying drawings. Those skilled in the art should understand that these embodiments are merely used to explain the technical principles of the present disclosure, and are not intended to limit the protection scope of the present disclosure.

### First Embodiment

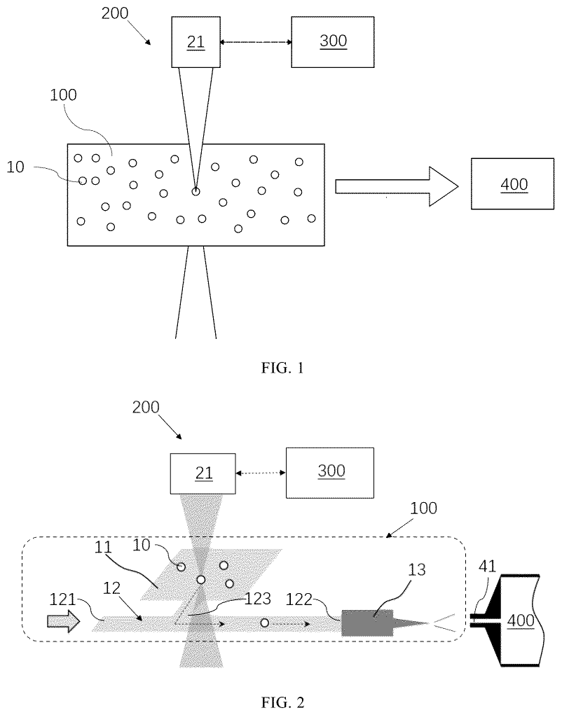

FIG. 1 is a schematic structural diagram of an analytical system in the present embodiment. As shown in FIG. 1, the analytical system includes a fluid system 100, an optical tweezer 200, an optical detector 300, and a mass spectrometer 400.

A specific shape structure of the fluid system 100 is not limited, for example, the fluid system 100 may be a housing structure containing a fluid therein, or may be formed as a plate-shaped structure having a surface with a grooved flow channel. The fluid stored in or flowing through the fluid system 100 includes at least solution containing sample particles 10, in which the sample particles 10 are suspended in the solution, and the fluid system 100 is formed as a light-transmitting structure for a light beam to pass through at a position where the solution is stored in or flows through.

The optical tweezer 200 include one or more laser generators 21, the one or more laser generators 21 emit one or more beams of strongly converged laser light towards fluid in the fluid system 100, an optical potential well is formed at a position where the one or more beams of laser light converge in the fluid, and single particles (all particles in the solution, including the sample particles 10) located in the optical potential well are bound by optical gradient force, so as to be fixed in the optical potential well, thereby separating and capturing the single particles in the solution. Due to relative movement between the optical tweezer 200 and the fluid system 100, the position of the optical potential well in the fluid system 100 can be changed, and the particles in the optical potential well are bound by the optical gradient force and also move transversely therewith, that is, the optical tweezer 200 drives the particles to move relative to the fluid system 100, thereby transporting the particles in the fluid system 100 through the optical gradient force.

The optical detector 300 can detect optical information of the particles so as to recognize and optically detect the particles in the solution or the particles captured by the optical tweezer 200, and the optical detector 300 can be any instrument capable of recognizing and detecting single or multiple sample particles 10, for example, one or a combination of a Raman spectrometer, an infrared spectrometer, a fluorescence analyzer, and an optical microscope. Preferably, the optical detector 300 is a Raman spectrometer, the optical tweezer 200 may be used as a detection light source of the Raman spectrometer. When the optical tweezer 200 captures the sample particles 10, the Raman spectrometer can obtain substance components of the sample particles 10 and molecular structure information of the substance based on the scattering spectrum between the laser beam of the optical tweezer 200 and the sample particles 10, the device structure is simpler, and a detection process is faster and more accurate.

The mass spectrometer 400 is arranged at a succeeding stage of the fluid system 100. For example, for the fluid system 100 having fluid flow, the mass spectrometer 400 may be arranged at a tail end of a fluid flow path and configured to receive ionized sample particles 10, and perform substance composition detection on the sample particles 10.

It should be noted that the sample particles 10 in the present embodiment may be any particles capable of being captured by the optical tweezer, such as ions, neutral particles, single cells, organelles, and single-celled microorganisms, but the present disclosure is not limited thereto, and preferably, the sample particles 10 may be one or a combination of cells, organelles, single-celled microorganisms, so that the analytical system provided in the present embodiment may be used as a full-automatic single-cell multi-dimensional analysis instrument, reduce the technical difficulty and implementation cost of single-cell comprehensive analysis, and improve an analysis speed. The analytical system is applied to the fields of drug development and tumor treatment, and spectrum information and mass spectrum information can respectively provide pharmacodynamics and pharmacokinetic information of single cells, so that high-throughput drug sensitivity screening is achieved, the problem of tumor cell heterogeneity is solved, and anti-cancer drug research and development are accelerated; and the analytical system is applied to the fields of biological research and the like, spectrum or immunofluorescence can be used as a judgment basis, special cells can be quickly and accurately found from a large number of background cells, and meanwhile, the optical tweezer 200 can be controlled to select all particles in the solution according to requirements, so that mass spectrometry analysis of specific cells is quickly and automatically completed, for example, circulating tumor cells can be quickly and accurately screened and analyzed from a large number of normal cells.

Specifically, the solution containing the sample particles 10 is stored in or flowed through the fluid system 100, the laser generator 21 of the optical tweezer 200 emits a laser beam into the fluid system 100, the laser beam is converged in the fluid system 100 to form an optical potential well, and the single sample particles 10 are captured and fixed in the solution. The optical detector 300 performs recognition and detection analysis on the sample particles 10 in the solution or the sample particles 10 captured by the optical tweezer 200, provides optical information (substance composition, substance structure and the like) of the captured sample particles 10, according to the detection result of the optical detector 300, the optical tweezer 200 screen and capture appropriate sample particles 10, and then drives the single sample particles 10 to be transported in the fluid system 100 by the optical gradient force generated by the optical tweezer 200, and the single sample particles 10 flow into the mass spectrometer 400 at a succeeding stage to further perform mass spectrometry detection.

In the present embodiment, the optical tweezer 200 can capture and transport single sample particles 10 from the solution, and at the same time or before the optical tweezer 200 capture and transport single sample particles 10, the optical detector 300 can recognize and detect optical information of the sample particles 10 so as to preferentially detect particles in the solution, so that the optical tweezer 200 can selectively capture single target sample particles from the solution. Finally, the sample particles can be transversely moved at least partially by the optical tweezer 200, and the single sample particles 10 are fed into the mass spectrometer 400 for detection. Since the optical tweezer 200 are used to directly capture, in-situ detect and move the sample particles, there is no need to manually transfer samples, so that the test flux of the optical detector 300 can be adapted to the mass spectrometer, thereby quickly, accurately, and automatically completing the recognition, capture, control, and detection processes of the sample particles 10.

In particular, in one analysis process of the analytical system of the present embodiment, it is possible to simultaneously complete the optical information detection and mass spectrometry information detection of the single sample particles 10, so that optical properties and composition properties of the single sample particles 10 can be monitored simultaneously, and in particular, pharmacokinetics and pharmacodynamics of single cell levels can be monitored simultaneously in single cell drug screening.

FIG. 2 is a schematic structural diagram of an exemplary analytical system in the present embodiment.

As an exemplary embodiment, as shown in FIG. 2, the fluid system 100 includes a reservoir 11 storing a solution containing the sample particles 10 and a fluid channel 12 in communication with the reservoir 11.

The fluid channel 12 and the reservoir 11 are both formed into a light-transmitting structure, the fluid channel 12 is provided with a fluid inlet 121 and a fluid outlet 122, the fluid inlet 121 is provided with a medium solution which is continuously introduced and does not contain the sample particles 10, the fluid outlet 122 is provided with an ionization device 13 and an ion inlet 41 of the mass spectrometer 400 arranged in correspondence with the ionization device 13, and the ionization device 13 may be an electrospray ionization source, an atmospheric pressure chemical ionization source, an inductively coupled plasma ionization source, or a matrix-assisted laser desorption/ionization source. Taking the electrospray ionization source as an example, the fluid outlet 122 of the fluid channel 12 may be a needle tip end thereof, after the fluid is ejected from the tip end, it is ionized under the action of the electrode, and the ionized sample particles 10 enter the ion inlet 41 of the mass spectrometer 400 from the ion inlet 41 of the mass spectrometer 400 for detection.

The reservoir 11 is in communication with a reservoir communication port 123 in the middle of the fluid channel 12 (at a position other than the fluid inlet 121 and the fluid outlet 122), and the solution in the reservoir 11 is relatively still stored in the reservoir 11 when not driven by external force. The reservoir 11 and the fluid channel 12 are respectively arranged to prevent the sample particles 10 that have not been separated and recognized from flowing into the mass spectrometer 400 at a succeeding stage of the fluid system 100 along with the solution, and the solution in the reservoir 11 remains still to prevent the solution from affecting binding force of the optical tweezer 200.

Specifically, when the sample particles 10 in the reservoir 11 are captured and controlled, the optical tweezer 200 emit a laser beam towards the solution in the reservoir 11, single sample particles 10 are captured and fixed in the solution in the reservoir 11, and then, through relative movement between the optical tweezer 200 and the fluid system 100, and preferably, the laser generator 21 of the optical tweezer 200 remains stationary, and the fluid system 100 moves, so that the optical potential well generated by the optical tweezer 200 in the fluid system 100 slowly moves from the reservoir 11 into the fluid channel 12, the sample particles 10 bound to the optical potential well move into the fluid channel 12 accordingly, the medium solution in which the sample particles 10 are continuously flowing in the fluid channel 12 is carried to flow towards the fluid outlet 122, ionization occurs at the fluid outlet 122, and the ionized sample particles 10 enter the mass spectrometer 400 at the succeeding stage for mass spectrometry detection.

In the present embodiment, after the optical tweezer 200 captures the sample particles 10 in the reservoir 11, as long as the optical tweezer 200 moves at the reservoir communication port 123 between the reservoir 11 and the fluid channel 12, and the single sample particles 10 are transported to the reservoir communication port 123 of the fluid channel 12, the sample particles 10 may flow in the fluid channel 12 along with the medium solution in the fluid channel 12 to the ionization device 13 at the fluid outlet 122, the ionized sample particles 10 can directly enter the ion inlet 41 of the mass spectrometer 400 for detection, a transport distance of the optical tweezer 200 is shortened, and transporting the sample particles 10 through the fluid can further improve a transport speed of the sample particles 10 on the basis of ensuring the completion of the separation, recognition and optical detection of the sample particles 10, the output flux of the sample particles 10 in the fluid system 100 is increased, and the detection efficiency of the analytical system is improved.

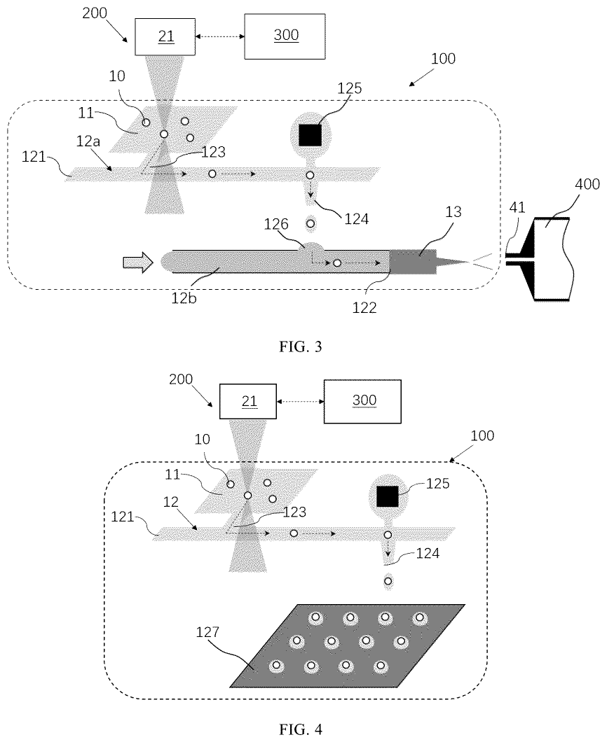

As another embodiment, as shown in FIG. 3, the fluid channel 12 includes a first fluid channel 12a and a second fluid channel 12b.

The fluid inlet 121, the reservoir communication port 123 and a nozzle opening 124 are sequentially formed in the first fluid channel 12a, and fluid in the first fluid channel 12a flows in from the fluid inlet 121, carries the sample particles 10 transported by the optical tweezer 200 when flowing through the reservoir communication port 123, and then flows out of the nozzle opening 124. The nozzle opening 124 is a through hole formed in the fluid channel 12, and an inkjet actuator 125 is arranged opposite to the nozzle opening 124 and configured to print fluid in the fluid channel 12 to form droplets, so that fluid carrying the sample particles 10 in the first fluid channel 12a is printed by the inkjet actuator 125 into droplets wrapped with single sample particles 10, and flows out of the first fluid channel 12a one by one in a form of droplets from the nozzle opening 124.

The second fluid channel 12b has a channel opening 126 opposite to the inkjet actuator 125 across the nozzle opening 124 and is used for receiving droplets wrapped with sample particles 10 expelled from the nozzle opening 124 one by one, and a tail end of the second fluid channel 12b is the ionization device 13, which is an electrospray ionization source. A gas pressure at the tail end of the second fluid channel is lower than the channel opening 126, and a gas pressure difference drives the sample particles 10 to flow along with the solution to the ionization device 13. Preferably, the tail end of the second fluid channel 12b is formed as a nano-tip, and high voltage (1 kV-5 kV) is applied to the droplets of the sample particles 10 through the electrode. Under the action of the high-voltage electric field, droplets containing single sample particles 10 are ejected from the tip end of the second fluid channel 12b to form an electrospray, and sample ions in the electrospray enter the ion inlet 41 of the mass spectrometer 400 to perform mass spectrometry detection.

In the present embodiment, an upstream of the fluid system 100 is provided with the optical tweezer 200 and the optical detector 300, and after the sample particles 10 in the reservoir 11 are captured, separated, recognized and detected, the sample particles 10 are transported to the fluid channel 12 by the optical tweezer 200, so that droplets containing the single sample particles 10 can be expelled one by one from the nozzle opening 124 by setting the transport speed of the optical tweezer 200 and a printing speed of the inkjet actuator 125. The droplets containing the single sample particles 10 printed by the inkjet actuator 125 enter the channel opening 126 of the second fluid channel 12b through the nozzle opening 124, and are ionized in the second fluid channel 12b, so that the single sample particles 10 can be ionized in the single droplets without affecting each other, and the ionized single sample ions directly enter the mass spectrometer 400 through the second fluid channel 12b for detection, which is faster and more accurate.

As another embodiment, as shown in FIG. 4, the fluid system 100 further includes a target plate 127 arranged below the nozzle opening 124. The droplets containing the single sample particle 10 printed by the inkjet actuator 125 are dropped onto the target plate 127 through the nozzle opening 124, and one target plate 127 can simultaneously arrange a plurality of droplets, so that mass spectrometry detection can be performed after the plurality of droplets on the target plate 127 are ionized.

In particular, the target plate 127 on which the droplets are arranged may be directly used as the target plate 127 of the matrix-assisted laser desorption/ionization device, thereby completing ionization of a plurality of droplets on the target plate 127 in the matrix-assisted laser desorption/ionization device.

In some exemplary embodiments of the present disclosure, the analytical system further includes an image recognition system (not shown) configured to recognize the sample particles 10 from the solution. The image recognition system may be an image recognition device such as an optical microscope or an optical camera, and the image recognition system can recognize and screen the sample particles 10 in the solution in a larger range before capturing the sample particles 10, thereby further improving the capture efficiency of the optical tweezer 200 on the sample particles 10 and the detection speed of the optical detector 300.

### Second Embodiment

There is provided an analytical method according to a second embodiment of the present disclosure, the analytical method including:
a capturing step S1 for capturing sample particles in solution which is stored in or flowing through a fluid system by an optical tweezer;
an optical analysis step S2 for detecting optical information of the sample particles; and
a mass spectrometry detection step S3 for driving the sample particles towards a mass spectrometer at least partially by the optical tweezer and detecting mass spectrum information of the sample particles.

Preferably, the optical analysis step S2 is performed simultaneously with the capturing step S1, or the optical analysis step S2 is performed before the capturing step S1.

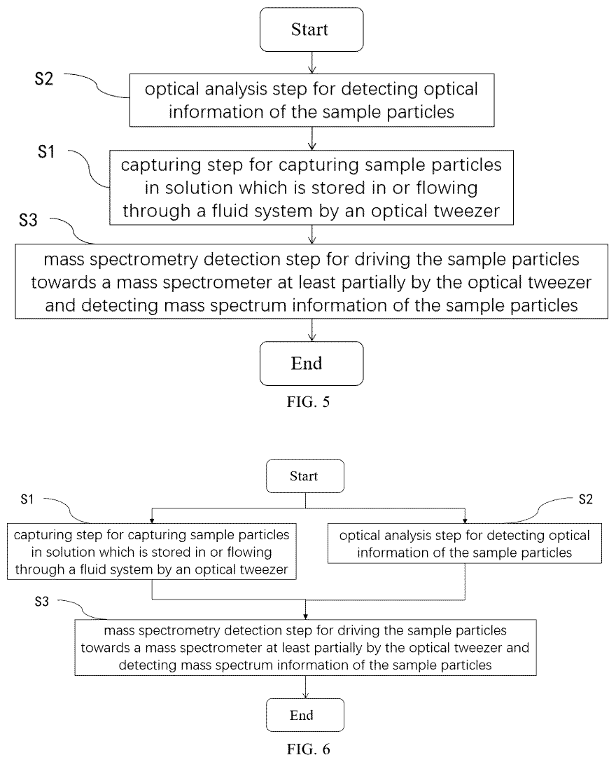

It should be noted that the analytical method in the present embodiment may be applied to the analytical system in the first embodiment, or may be applied to another analytical system coupled by an optical tweezer, an optical detector, and a mass spectrometer. FIGS. 5 and 6 respectively show two operation modes of the analytical method in the present embodiment, and the analytical system in FIG. 2 of the first embodiment is taken as an example to describe the two operation modes of the analytical method in the present embodiment.

As shown in FIG. 5, when detecting and analyzing the sample particles 10 in the reservoir 11, firstly, the optical analysis step S2 is performed, taking that an optical detection device is a fluorescence microscope as an example, the target sample particles (single cells) can be detected and found in the solution first through fluorescence. Then, the capturing step S1 is performed, the optical tweezer 200 emits laser beams toward the solution in the reservoir 11, and the single sample particles 10 are captured and fixed in the solution of the reservoir 11. Next, according to the recognition and detection results of the optical analysis step S2, the mass spectrometry detection step S3 is performed, the optical tweezer 200 and the fluid system 100 move relative to each other, the sample particles 10 recognized by the optical detector 300 are driven by the optical gradient force to move from the reservoir 11 to the fluid channel 12, the sample particles 10 are carried by the continuously flowing fluid in the fluid channel 12 and flow toward the fluid outlet 122, ionization occurs at the fluid outlet 122, and the ionized sample particles 10 enter the mass spectrometer 400 at the succeeding stage for mass spectrometry detection.

As shown in FIG. 6, when detecting and analyzing the sample particles 10 in the reservoir 11, firstly, the capturing step S1 is performed, the optical tweezer 200 emits a laser beam toward the solution in the reservoir 11, and the single sample particles 10 are captured and fixed in the solution of the reservoir 11, the optical analysis step S2 is performed simultaneously with the capturing step S1, the laser beam of the optical tweezer 200 is used as a detection light source, the optical detector 300 performs detection and analysis on the sample particles 10 captured by the optical tweezer 200, recognizes the sample particles 10 in the solution and detects optical information (substance composition, substance structure and the like) of the sample particles 10. Then, the mass spectrometry detection step S3 is performed, the optical tweezer 200 and the fluid system 100 move relative to each other, the sample particles 10 recognized by the optical detector 300 are driven by the optical gradient force to move from the reservoir 11 to the fluid channel 12, the sample particles 10 are carried by the continuously flowing fluid in the fluid channel 12 and flow toward the fluid outlet 122, ionization occurs at the fluid outlet 122, and the ionized sample particles 10 enter the mass spectrometer 400 at the succeeding stage for mass spectrometry detection.

The technical solutions of the present disclosure have been described with reference to the accompanying drawings, but it is easily understood by those skilled in the art that the protection scope of the present disclosure is obviously not limited to these specific embodiments. Those skilled in the art can make equivalent changes or substitutions to related technical features without departing from the principle of the present disclosure, and the technical solutions after these changes or substitutions shall fall within the protection scope of the present disclosure.

1. An analytical system comprising:
a fluid system, where solution containing sample particles is stored in or flowing through;
an optical tweezer arranged towards the fluid system and configured to capture the sample particles in the fluid system;
an optical detector configured to detect optical information of the sample particles in the fluid system; and
a mass spectrometer arranged at a succeeding stage of the fluid system,
the sample particles in the fluid system being at least partially driven by the optical tweezer toward the mass spectrometer.

2. The analytical system according to claim 1, wherein the sample particles are one or a combination of cells, organelles, and single-celled microorganisms.

3. The analytical system according to claim 1, wherein the fluid system comprises a reservoir storing the solution and a fluid channel communicating with the reservoir, and the optical tweezer is operable to move between the reservoir and the fluid channel, thereby the sample particles being moved from the reservoir to the fluid channel at least partially by optical gradient force.

4. The analytical system according to claim 3, wherein fluid in the fluid channel flows toward an outlet end, an ionization device is arranged at the outlet end of the fluid channel, and an ion inlet of the mass spectrometer is arranged opposite to the ionization device.

5. The analytical system according to claim 4, wherein the fluid system further comprises:
a nozzle opening formed at the fluid channel and located downstream of the reservoir;
an inkjet actuator arranged in correspondence with the nozzle opening, droplets containing the sample particles expelled one by one through the nozzle opening.

6. The analytical system according to claim 5, wherein the fluid channel comprises a first fluid channel and a second fluid channel, an outlet of the reservoir, the nozzle opening and the inkjet actuator are all connected to the first fluid channel, the ionization device is connected to the second fluid channel, and the second fluid channel has a channel opening arranged in correspondence with the nozzle opening, for receiving the droplets expelled through the nozzle opening.

7. The analytical system according to claim 5, wherein the fluid system further comprises a target plate arranged below the nozzle opening.

8. The analytical system according to claim 4, wherein the ionization device is an electrospray ionization source, an atmospheric pressure chemical ionization source, an inductively coupled plasma ionization source, or a matrix-assisted laser desorption/ionization source.

9. The analytical system according to claim 1, wherein the optical detector is one or a combination of a Raman spectrometer, an infrared spectrometer, a fluorescence analyzer, or an optical microscope.

10. The analytical system according to claim 1, further comprising
an image recognition system configured to recognize the sample particles from the solution.

11. An analytical method comprising:
a capturing step for capturing sample particles in solution which is stored in or flowing through a fluid system by an optical tweezer;
an optical analysis step for detecting optical information of the sample particles; and
a mass spectrometry detection step for driving the sample particles towards a mass spectrometer at least partially by the optical tweezer and detecting mass spectrum information of the sample particles.

12. The analytical method according to claim 11, wherein the optical analysis step is performed simultaneously with the capturing step, or the optical analysis step is performed before the capturing step.
